(19) United States
(12) Patent Application Publication
(10) Pub. No.: US 2004/0106042 A1
(43) Pub. Date: Jun. 3, 2004

(54) Energy accumulating device and its fabrication method

(75) Inventors: Takuma Asari, Hyogo (JP); Susumu Nomoto, Kyoto (JP)

Correspondence Address: McDERMOTT, WILL & EMERY, 600 13th Street, N.W., Washington, DC, 20005-3096, US

(73) Assignee: MATSUSHITA ELECTRIC INDUSTRIAL CO., LTD.

(21) Appl. No.: 10/622,510

(22) Filed: Jul. 21, 2003

(30) Foreign Application Priority Data
Jul. 29, 2002 (JP) P2002-219455

(51) Int. Cl. H01M 4/62; H01M 10/04

(52) U.S. Cl. 429/232; 29/623.1

(57) ABSTRACT

An energy accumulating device of the present invention is an energy accumulating device having a pair of electrodes, a separator set between the electrodes, a pair of collectors, a pair of conductive layers respectively set between the electrode and the collector, and an electrolytic solution, in which at least one of the conductive layers includes aspheric conductive particles extending at least in one direction and scaly graphite particles are preferable as the conductive particles.

### FIELD OF THE INVENTION

The present invention relates to an energy accumulating device such as an electrochemical capacitor or a battery and its fabrication method.

### BACKGROUND OF THE INVENTION

Electrochemical capacitor and battery have been typical energy accumulating devices so far and they are already used in markets making the best use of their characteristics.

Electrochemical capacitors include an electric double layer capacitor using activated carbon as a polarized electrode and using only an electric double layer formed on the interface between activated-carbon-pore surface and electrolytic solution or a redox capacitor using transition metal oxide such as ruthenium oxide whose valence continuously changes or conductive polymer that can be doped.

Moreover, batteries can be roughly divided into a secondary battery which can be charged or discharged by using intercalation or chemical reaction of an active material and a primary battery which, basically, cannot be recharged after it is once discharged.

The most basic configuration common to these various energy accumulating devices is an electrode containing mainly an active material which can discharge energy in its principle. Moreover, a collector electrically connected with an electrode and having electronic conductivity is necessary in order to extract the energy accumulated in the electrode to the outside.

A collector generally uses a metal having a very low resistance such as aluminum, copper, or stainless steel because it is necessary to efficiently propagate the energy of an active material. However, when using an electrolytic solution having a metal corrosiveness such as a sulfuric-acid aqueous solution, a conductive rubber-based material may be used.

Resistance components of an energy accumulating device are roughly divided into two types such as electron resistance and ion resistance. Moreover, though the electron resistance is controlled by various factors, the contact resistance between an electrode and a collector rises extremely while a device is operated.

Therefore, to lower or prevent the contact resistance from rising while a device is operated, it is devised to newly form a conductive layer between an electrode and a collector.

In the case of this secondary battery, it is disclosed in the official gazette of Japanese Patent Laid-Open No. (Sho) 56-38770 to apply a colloidal-carbon containing solution obtained by suspending powder carbon in water to the inside of a metallic battery vessel also serving as a positive-electrode terminal, dry the inside of the vessel, and then set a positive electrode.

The above technique is further improved as in the official gazette of Japanese Patent Laid-Open No. (Hei) 10-144298, which discloses reduction of the adhesiveness due to expansion or contraction of an active material contained in an electrode is controlled by making the ratio of a binder contained in a conductive layer higher than that in the electrode. Moreover, it is disclosed in the official gazette of Japanese Patent Laid-Open No. 2002-42888 to improve the adhesiveness and the high-rate discharge characteristic by using carboxymethylcellulose as a binder.

Moreover, with respect to electric double layer capacitor, it is disclosed in the official gazette of Japanese Patent Laid-Open No. (Sho) 59-3915 to form a conductive layer made of graphite or carbon black between an electrode and a metallic case contacting the electrode and between an electrode and a metallic lid contacting the electrode.

The above technique is further improved and the official gazette of Japanese Patent Laid-Open No. (Hei) 6-84699 discloses a method of increasing the number of contact points and decreasing the contact resistance with an electrode by constituting particle diameters of a conductive material used for a conductive layer by a mixture of a diameters larger and smaller than an activated-carbon diameter used for an electrode.

The following requests have newly appeared because the purpose of an energy accumulating device has been recently applied to portable equipment.

First, since the occupation ratio of an energy accumulating device becomes large, it is necessary to downsize the energy accumulating device without changing its characteristic by greatly increasing the energy quantity which can be stored per unit weight or volume, that is, energy density. Second, with the downsizing of the device, it is necessary to mount an energy accumulating device on a substrate or the like in accordance with a design assuming exchange because a mechanism for exchanging the energy accumulating device or a space in which the device is set is restricted as equipment is decreased in size.

It has been attempted, in response to the first request for increase of energy density, to raise a necessary withstand voltage by developing a process and materials for use, and it has been attempted, in response to the second request for mounting an energy accumulating device on a substrate, to realize a high heat resistance allowing reflow soldering.

However, these two countermeasures cause new problems which have not come to the surface in conventional specifications in the case of an energy accumulating device, especially the above electric double layer capacitor. One of the problems is the rise of an internal resistance due to the fact that an energy accumulating device is exposed to a high temperature of hundreds of degrees which has not been assumed so far even for several seconds to tens of seconds at the time of reflow soldering and the increase of a leakage current on the surface of a collector and a quick rise of an internal resistance due to the increase of the leakage current when operating the device for a long time at a high withstand voltage.

It is clarified through our various study results that the contact resistance between an electrode and a collector accounts for a large percent of the rise of the internal resistance at the time of reflow or operation at a high withstand voltage. Though it is attempted to form a carbon-based conductive layer made of spherical graphite or the like on the already publicly-known composition plane between an electrode and a collector, no essential solution is obtained. Moreover, the techniques described in the above publicly-known documents are not described from the viewpoint of reflow resistance.

### SUMMARY OF THE INVENTION

Therefore, a main object of the present invention is to provide an energy accumulating device which suppresses the rise of an internal resistance and its fabrication method.

An energy accumulating device of the present invention is an energy accumulating device having a pair of electrodes, a separator set between the electrodes, a pair of collectors, a pair of conductive layers respectively formed between the electrode and the collector, and an electrolytic solution, in which at least one of the conductive layers includes aspheric conductive particles extending in at least one direction.

In the case of the present invention, it is preferable that the conductive particles be made of scaly graphite.

An energy accumulation device fabrication method of the present invention is a fabrication method of an energy accumulating device having a pair of electrodes, a separator set between the electrodes, a pair of collectors, a pair of conductive layers respectively formed between the electrode and the collector, and an electrolytic solution, which includes a step of preparing conductive-layer paste by mixing aspheric conductive particles extending in at least one direction with a binder and a solvent, a step of applying obtained conductive-layer paste onto a collector, drying the obtained paste-applied layer, and a step of electrically connecting an electrode onto a dried conductive layer.

Moreover, the energy accumulation device fabrication method of the present invention is a fabrication method of an energy accumulating device having a pair of electrodes, a separator set between the electrodes, a pair of collectors, a pair of conductive layers respectively formed between the electrode and the collector, and an electrolytic solution, which includes a step of preparing conductive-layer paste by mixing aspheric conductive particles extending in at least one direction with a binder and a solvent, a step of applying obtained conductive-layer paste onto a collector, a step of attaching an electrode without drying the obtained paste-applied layer, and a step of drying an electrode and a collector integrated through conductive layer paste.

### BRIEF DESCRIPTION OF THE DRAWINGS

These and other objects as well as advantages of the invention will become clear from the following description of the preferred embodiments of the invention with reference to the accompanying drawings, wherein;

FIG. 1 is a sectional view of a coin-shaped energy accumulating device of an embodiment of the present invention;

FIG. 2 is a sectional view of a reflow-type coin-shaped energy accumulating device;

FIG. 3 is a temperature profile at the time of reflow;

FIG. 4 is a sectional view for explaining an electron conducting route of a carbon-based conductive layer of the embodiment in FIG. 1 in the initial state;

FIG. 5 is a sectional view for explaining an electron conducting route of a conventional carbon-based conductive layer in the initial state;

FIG. 6 is a sectional view for explaining an electron conducting route after a reactive product is attached to the carbon-based conductive layer of the embodiment in FIG. 1;

FIG. 7 is a sectional view for explaining an electron conducting route after a reactive product is attached to a conventional carbon-based conductive layer;

FIGS. 8A to 8D are schematic views for explaining steps of a fabrication method of an embodiment of the present invention;

FIGS. 9A to 9D are schematic views for explaining steps of a fabrication method of a preferable embodiment of the present invention;

FIGS. 10A to 10E are schematic views for explaining steps of a fabrication method of another preferred embodiment of the present invention;

FIGS. 11A to 11E are schematic views for explaining steps of a fabrication method of still another preferred embodiment of the present invention; and

FIG. 12 is a perspective view of a cylindrical energy accumulating device of other embodiment of the present invention shown by cutting out a part of the device.

In all these figures, similar components are indicated by the same numerals.

### DETAILED DESCRIPTION OF THE PREFERRED EMBODIMENTS

Embodiments of the present invention are described below by referring to the accompanying drawings.

(Embodiment 1)

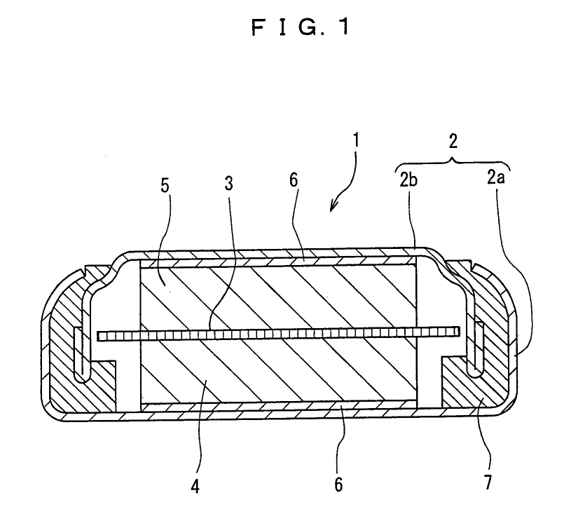

FIG. 1 is a sectional view of a coin-shaped electric double-layer capacitor serving as an energy accumulating device of the present invention.

The coin-shaped energy accumulating device 1 of this embodiment has a pair of polarized electrodes 4 and 5, a separator 3 set between the electrodes 4 and 5, a pair of collectors 2a and 2b (also serving as a positive-pole case and a negative-pole case) electrically connected to the electrodes 4 and 5 respectively, and an electrolytic solution (not illustrated). Symbol 7 denotes a gasket.

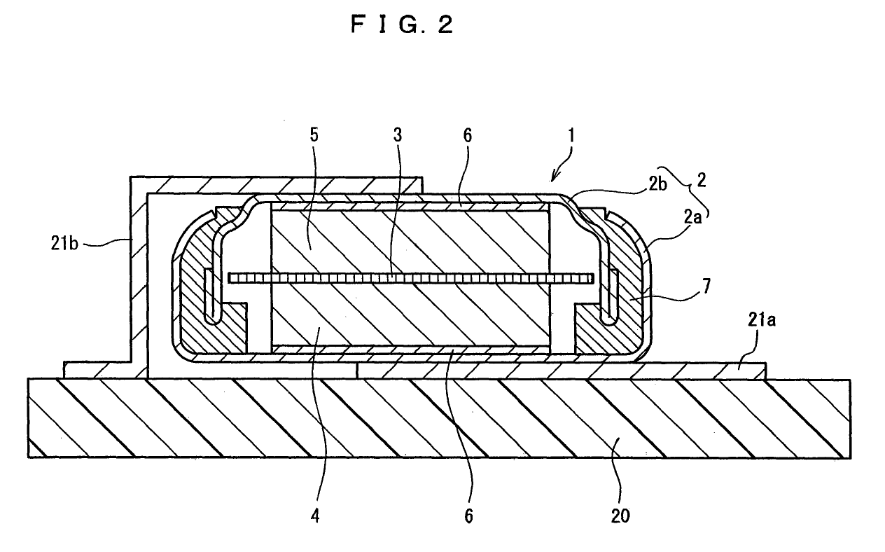

As shown in FIG. 2, in the case of the type to be mounted on a substrate 2 through reflow, a positive-pole tab 21a made of a rectangular flat lead plate and a negative-pole tab 21b made of a bent rectangular lead plate are set to the electrodes 4 and 5 through spot welding.

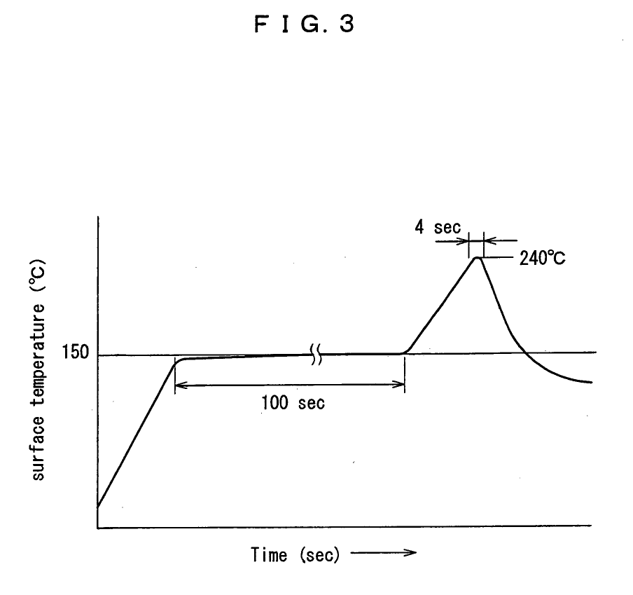

In this case, the reflow denotes a technique for simultaneously soldering a plurality of devices by previously putting not-melted solder on all portions of the devices to be soldered and heating them to a solder-melting temperature or higher together with a substrate instead of independently soldering each electronic part such as a coin-shaped electric double-layer capacitor or battery (hereafter referred to as device), which greatly decreases the fabrication time. At the time of the reflow, as shown by the typical temperature profile in FIG. 3, the whole substrate and each device are exposed to a high temperature such as 240° C. even for a short time after preheating them at approx. 150° C.

In FIG. 1, though the collectors 2a and 2b also serve as in case 2, a clad material obtained by attaching different types of metals to each other can be used according to necessity. In this case, only the electrode-side metal, that is the inside metal, functions as a collector.

The electrodes 4 and 5 are respectively constituted by an active material, conductive material, or bonding material in general. Various materials can be used as active materials in accordance with requested energy density, withstand voltage, output density, or low-temperature characteristic.

For example, when an output density or low-temperature characteristic is necessary to function as an electric double-layer capacitor which can be charged and discharged, it is only necessary to use activated carbon as an active material.

Moreover, when an energy density is necessary to function as a lithium-ion secondary battery which can be charged and discharged, lithium metal oxide such as lithium cobalt oxide can be used for a positive pole, and graphite for a negative pole.

To function as a good lithium-ion primary battery for one-time discharge, lithium metal oxide can be selected for a positive pole, and metal lithium for a negative pole.

Moreover, a conductive material or a bonding material used for an electrode does not principally depend on the type of energy accumulating device, but carbon black is used as a conductive material and fluorine-based resin or rubber-based resin is used as a bonding material. However, it is necessary to select a material that will not deteriorate due to a voltage range or temperature to be used as a conductive material and bonding material.

Also, the separator 3 does not principally depend on the type of accumulating device. However, when reflow is particularly necessary, the heat resistance is requested. When the heat resistance is not necessary, polypropylene or the like can be used. When the heat resistance is necessary, a cellulose-based material can be used.

Though a metal such as aluminum or stainless steel can be used for the collectors 2a and 2b, a clad material of aluminum or stainless steel may also be used.

It is necessary to select an electrolytic solution depending on the type of energy accumulating device. It is necessary to select a solvent having a proper potential window so that electrochemical decomposition does not occur depending on an operating voltage range. General propylene carbonate, ethylene carbonate, ethylmethyl carbonate, or a mixed solvent of them can be the options. However, when reflow is required, it is necessary to use a high-boiling-point solvent such as sulfolane so that an electrolytic solution does not boil at the time of reflow. As an electrolyte, various publicly-known materials can be employed, such as tetraethylammonium tetrafluoroborate for an electric double-layer capacitor and lithium pentafluorophosphate for a lithium-ion secondary battery.

In the case of this embodiment, a carbon-based conductive layer 6 containing aspheric conductive particles extending in one direction is formed on at least either of the composition plane between the electrode 4 and collector 2a and that between the electrode 5 and collector 2b or both of the planes in the case of this embodiment in addition to a general configuration of the above energy accumulating device.

Shapes of an aspheric particle extending in one direction include various shapes such as a scaly shape, elliptic ball shape (football shape), long eggplant shape, and acorn shape, and rectangular plate shape. Moreover, a flat aspheric shape is allowed. Furthermore, it is allowed for a conductive particle to have a shape extending in a plurality of directions. However, it is preferable that the conductive particle has a scaly or discoid shape in which one of the three axes (X, Y, and Z) is extremely smaller than the other two axes.

Any material such as a carbon-based material or metal may be used for a conductive particle, as long as the material has a high electron conductivity. However, it is preferable to use a carbon-based material so that it can be stably present in an energy accumulating device.

Moreover, scaly graphite is particularly preferable in carbon-based materials from the viewpoint of cost. This is because the scaly graphite is a natural material and it is unnecessary to carbonize a start material of the scaly graphite differently from the case of artificial graphite, and the scaly graphite can be easily produced and is already scaly before it is processed.

However, because scaly graphite has a graphite structure, it is not preferable to use the scaly graphite for conductive particles at the negative-pose side of a lithium-ion secondary battery. This is because there is a problem that the same phenomenon as in the case of an active material occurs because lithium atoms are intercalated at the time of charge, interlayer distances are changed, and the contact property between conductive particles, or with an electrode or a collector, is deteriorated. This is also described in the official gazette of Japanese Patent Laid-Open No. (Hei) 10-144298.

However, an electric double-layer capacitor having a narrow operating-potential range does not have the above problem. Moreover, in the case of a lithium-ion secondary battery, it is unnecessary to consider the above problem with positive-pole-side conductive particles.

Therefore, scaly graphite advantageous from the viewpoint of cost is described below as conductive particles. However, it is also possible to use another type of aspheric conductive particles extending in one direction.

The scaly graphite has an average particle diameter of 20 μm and an average thickness of 5 μm.

Because particles of the above scaly graphite are scaly and extend in one direction (longitudinal direction), the internal resistance can be decreased by increasing the contact area compared to the case of conventional spherical graphite.

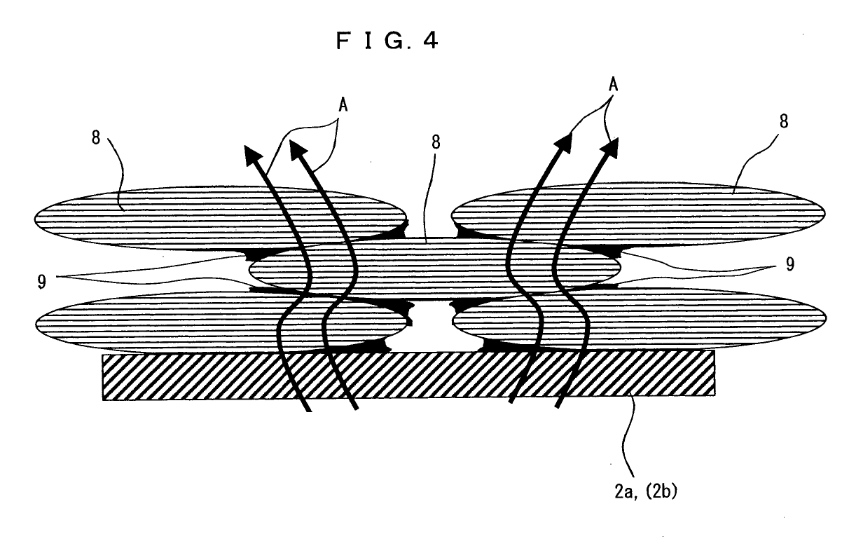

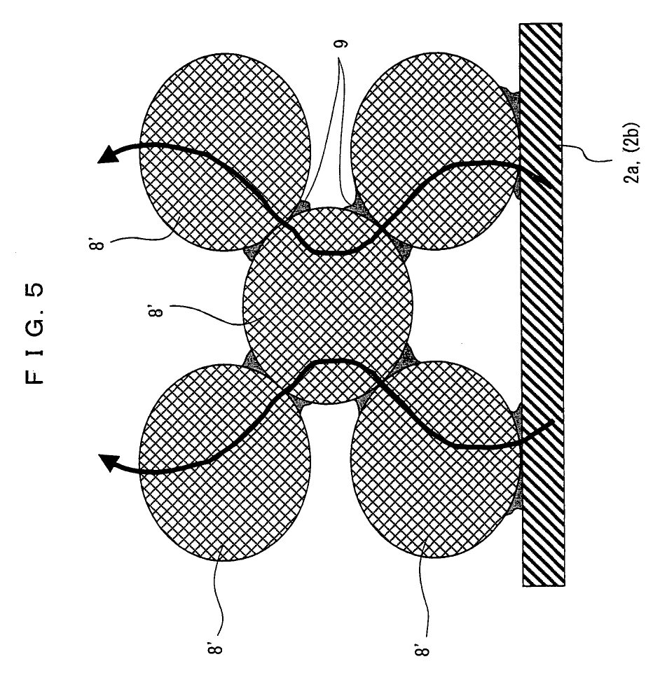

FIG. 4 is a locally enlarged sectional view for explaining an electron conducting route in the initial state in the carbon-based conductive layer 6 of this embodiment and FIG. 5 is a locally enlarged view for explaining an electron conducting route in the initial state in the carbon-based conductive layer of a conventional example using spherical graphite. The conventional example in FIG. 5 has a general configuration of the energy accumulating device shown in FIG. 1. That is, the conventional example uses spherical graphite for the carbon-based conductive layer 6 in FIG. 1.

FIGS. 4 and 5 show finished coin-shaped energy accumulating devices, in which symbol 8 denotes scaly graphite particle, 8′ denotes a conventional spherical graphite particle, and 9 denotes a resin contained in paste for a carbon-based conductive layer. An electrolytic solution is omitted.

Because each scaly graphite particle 8 is scaly and extending in one direction, contact areas between scaly graphite particles 8 and between a scaly graphite particle 8 and the collector 2a (2b) drastically increase compared to the case of the conventional spherical graphite particle 8′. Therefore, the internal resistance in the initial state can be reduced. This may be because an electron conducting route shown by an arrow A in FIG. 4 becomes wider than the case of the conventional example in FIG. 5. Moreover, because the collector 2a (2b) is covered with the scaly graphite particle 8 or conductive-layer paste in a wide range compared to the case of the conventional example in FIG. 5, a leakage current can be reduced by reducing the contact area between the collector 2a (2b) and a not-illustrated electrolytic solution. Thereby, the deterioration rate can be reduced.

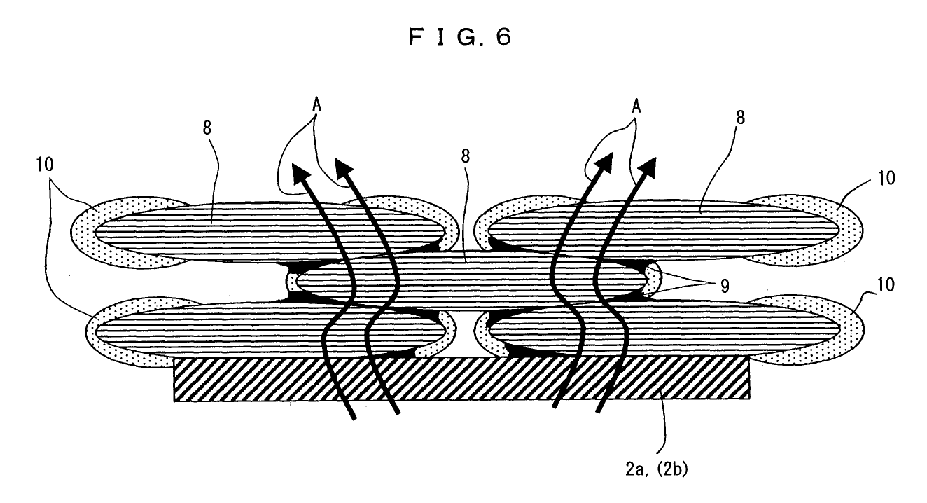

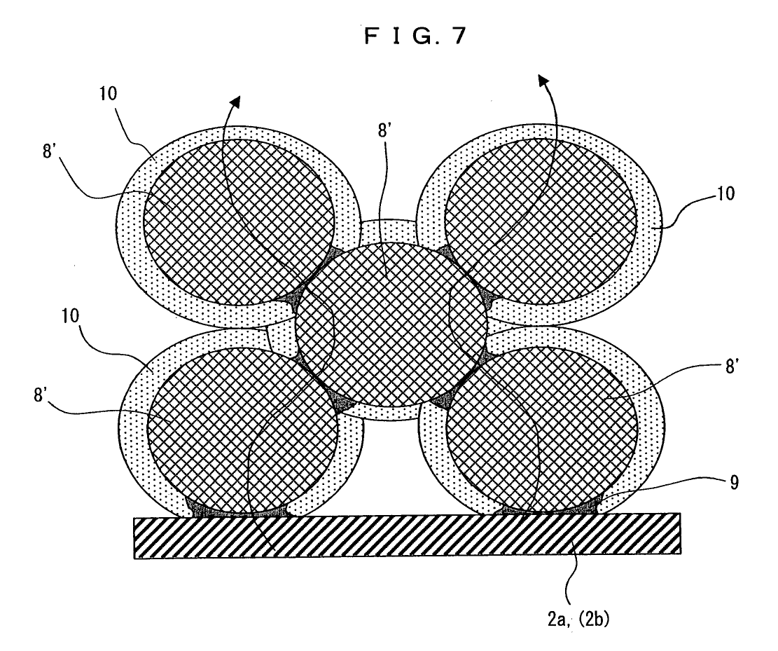

FIG. 6 is a locally enlarged view for explaining an electron conducting route after a reaction product is attached to the carbon-based conductive layer 6 of this embodiment and FIG. 7 is a locally enlarged view for explaining an electron conducting route after a reaction product is attached to the carbon-based conductive layer of a conventional example using spherical graphite. FIGS. 6 and 7 correspond to FIGS. 4 and 5. In FIGS. 6 and 7, symbol 10 denotes a reaction product.

According to this embodiment, even if a chemical reaction occurs between an internally-sealed electrolytic solution and the carbon-based conductive layer 6 and a reaction product 10 is produced, because the contact area between the scaly graphite particles 8 and that between the scaly graphite particles 8 and collectors 2a, 2b are large as shown in FIG. 6, the electron conductivity is kept as shown by the arrow A, an internal-resistance rise is suppressed and moreover the reaction product 10 is selectively attached to one end of the scaly graphite particle 8. Therefore, attachment of the product 10 to the electron conducting route is suppressed compared to the case of the conventional example in FIG. 7.

Thus, because the attachment area of the reaction product 10 is decreased in the case of the scaly graphite particle 8 compared to the case of the conventional spherical graphite particle 8′, the junction strength between scaly graphite particles 8 and that between the scaly graphite particle 8 and the collector 2a (2b) are increased and they can be effectively prevented from being separated due to a stress.

Thus, because scaly graphite particles 8 extending in one direction are laminated and an electron conducting route is formed, it is preferable that the number of scaly graphite particles 8 of the carbon-based conductive layer 6, the extending direction of which is parallel to the contact face of the collector 2a (2b), is larger than the number of scaly graphite particles 8, the extending direction of which is not parallel to the contact face, in order to increase the contact area and decrease internal resistance.

The fabrication method of the energy accumulating device 1 of this embodiment is described below.

As described above, it is preferable that more scaly graphite particles 8, the extending direction of which, that is, the longitudinal direction is parallel to the contact face of the collector 2a (2b), be included in the carbon-based conductive layer 6. There are various methods for realizing the above. However, a fabrication process using the paste for a carbon-based conductive layer obtained by mixing the scaly graphite particles 8 with a binder and a solvent is preferable because it is necessary to contain a bonding material for holding the bonding force between scaly graphite particles or with a collector. In the case of the fabrication process using the paste, because a solvent is finally dried, the scaly graphite particles 8 are dried while they are oriented parallel to a coated surface when the solvent is dried.

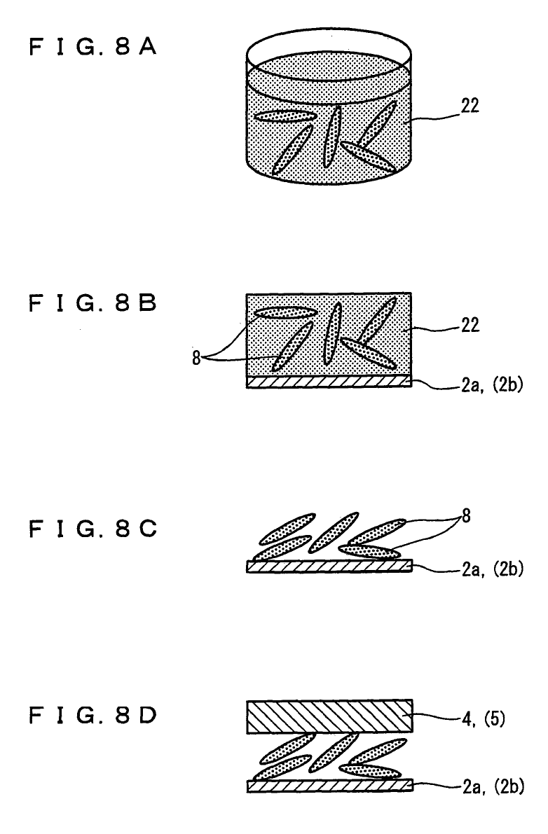

FIGS. 8A to 8D are schematic views for explaining steps of the fabrication method of this embodiment, each of which conceptually shows an oriented state of the scaly graphite particles 8 after each step.

First, a carbon-based conductive-layer paste 22 is prepared by mixing scaly graphite with a binder and a solvent as shown in FIG. 8A. The obtained carbon-based conductive-layer paste 22 is applied onto the collector 2a (2b) also serving as a case as shown in FIG. 8B. Then, the obtained paste-applied layer is dried to remove the solvent as shown in FIG. 8C, and an electrode 4 (5) is electrically connected onto the dried carbon-based conductive layer as shown in FIG. SD. The binder is not shown in FIGS. 8C or 8D.

Thus, by setting a separator between the electrodes 4 and 5 of the collectors 2a and 2b also serving as a case fabricated as described above, combining them, injecting an electrolytic solution into them, and hydraulically caulking them through a gasket, the coin-shaped energy accumulating device shown in FIG. 1 is obtained.

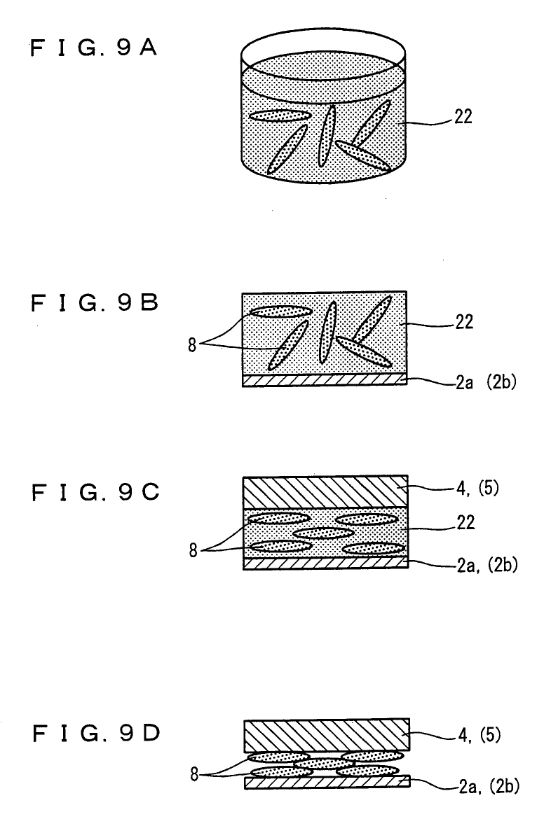

FIGS. 9A to 9D, which correspond to FIGS. 8A to 8D, are illustrations for explaining another fabrication method,

First, a carbon-based conductive-layer paste 22 is prepared by mixing scaly graphite with a binder and a solvent as shown in FIG. 9A, and the obtained carbon-based conductive-layer paste 22 is applied onto the collector 2a (2b), also serving as a case as shown in FIG. 9B. Then, the paste applied layer 22 is attached to the electrode 4 (5) without drying the layer 22 as shown in FIG. 9C and the electrode 4 (5) and the collector 2a (2b) are integrated through the carbon-based conductive-layer paste and dried as shown in FIG. 9D.

By setting the separator between the electrodes 4 and 5 of the collectors 2a and 2b also serving as a case formed as described above, combining them, and hydraulically caulking them through the gasket, the coin-shaped energy accumulating device shown in FIG. 1 is obtained.

In this case, the binder for the carbon-based conductive-layer paste includes polyamide imide, ethylene acrylic acid, polyvinyl butyral, urethane, CMC (carboxymethylcellulose), acrylic resin, and acrylic-styrene copolymer. These materials are used in accordance with the characteristic of carbon particle, but they do not influence characteristics independently of a material unless drying temperature and time are restricted.

Moreover, a solvent for the carbon-based conductive-layer paste includes water, isopropyl alcohol, N-methylpyrrolidone, and propylene-glycol monomethyl acetate. They do not influence characteristics depending on a material because they evaporate after drying.

To raise the orientation ratio so that scaly graphite particles, the longitudinal direction of which is parallel to the contact face of a collector, are included more than those, the longitudinal direction of which is not parallel to the contact face of the collector, it is preferable to further use the following two methods. In the first method, a centrifugal force is generated to orient carbon-based conductive-layer paste while it is wet and in the second method, the paste is contact-bonded.

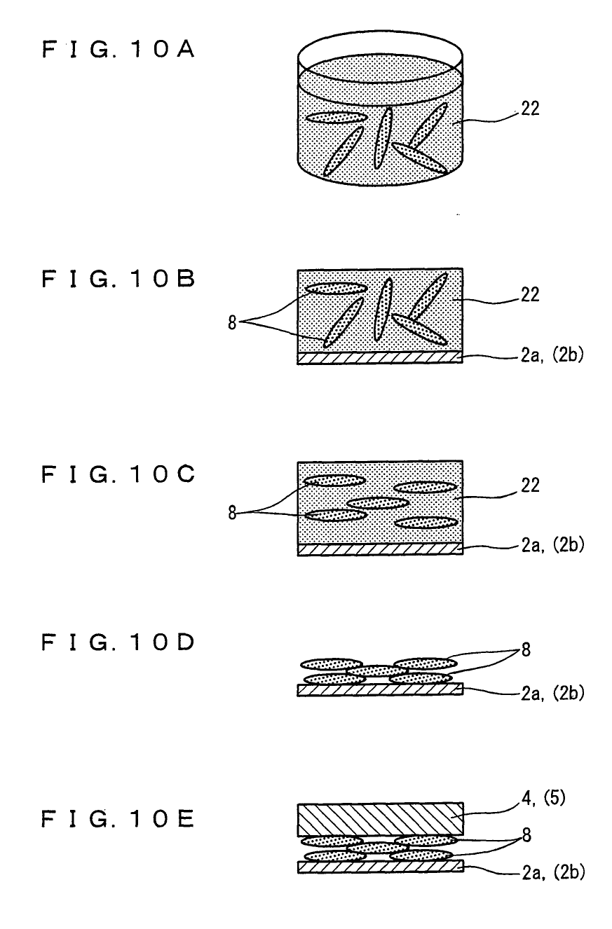

FIGS. 10A to 10E are illustrations for explaining the first method.

First, as shown in FIG. 10A, a carbon-based conductive-layer paste 22 is prepared by mixing scaly graphite with a binder and a solvent. Then, when applying the obtained carbon-based conductive-layer paste 22 onto the collector 2a (2b), the collector 2a (2b) is rotated as shown in FIG. 10B. That is, spin coating is executed. Scaly graphite particles 8 are oriented through the spin coating as shown in FIG. 10C. Then, the paste applied layer is dried as shown in FIG. 10D to electrically connect the electrode 4 (5) onto the dried carbon-based conductive layer as shown in FIG. 10E.

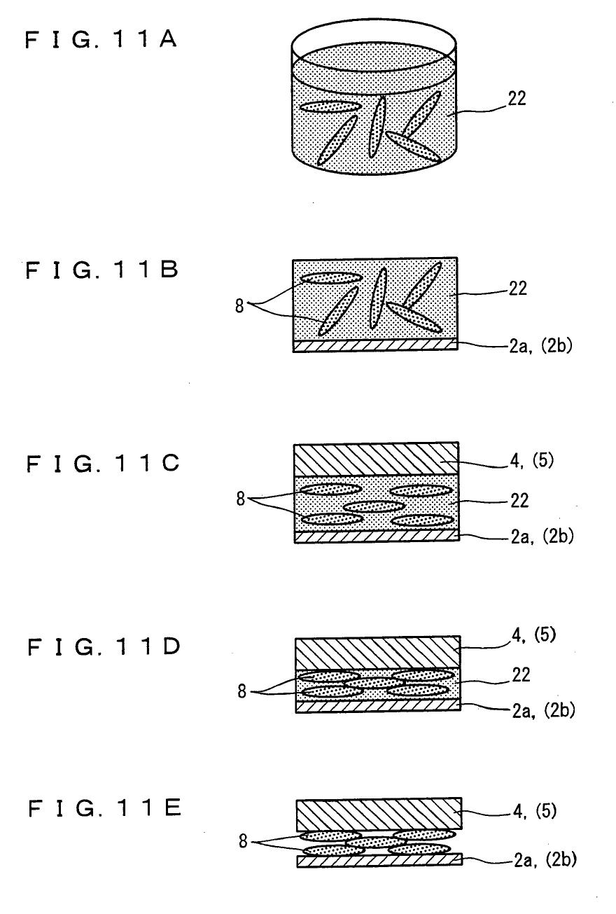

FIGS. 11A to 11E are illustrations for explaining the second method.

First, a carbon-based conductive-layer paste 22 is prepared by mixing scaly graphite with a binder and a solvent as shown in FIG. 11A and then, the obtained carbon-based conductive-layer paste 22 is applied onto the collector 2a (2b) as shown in FIG. 11B. Then, the electrode 4 (5) is attached without drying the paste applied layer 22 as shown in FIG. 11C to apply a pressure as shown in FIG. 11D. Thereafter, as shown in FIG. 11E, the electrode 4 (5) and the collector 2a (2b) are integrated through the carbon-based conductive layer paste and dried.

(Embodiment 2)

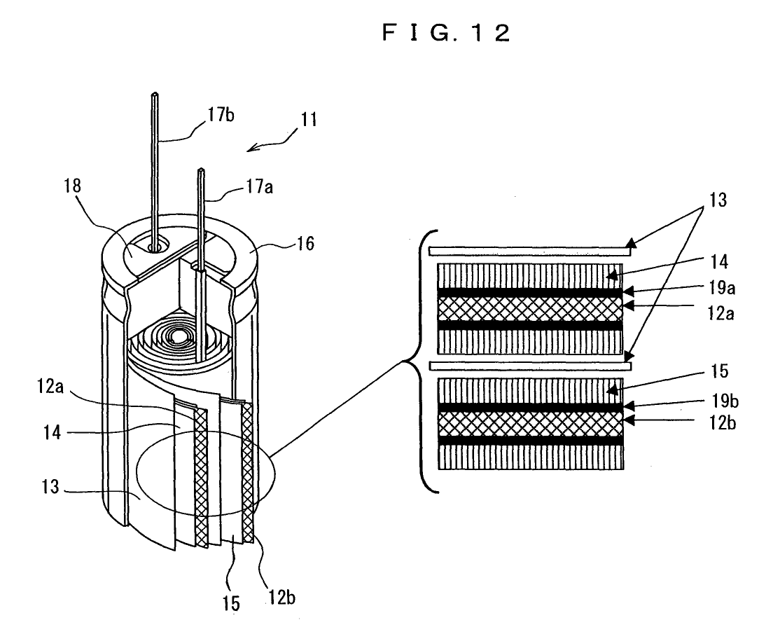

FIG. 12 shows a locally cut-out perspective view and a locally enlarged view of a cylindrical electric double-layer capacitor serving as a cylindrical energy accumulating device of another embodiment of the present invention.

The cylindrical energy accumulating device 11 of this embodiment is constituted by applying a positive electrode 14 to a positive-pole collector 12a at both surfaces thereof, applying a negative electrode 15 to a negative-pole collector 12b at both surfaces thereof, winding them with a separator 13 intervening, and sealing them in a case 16 together with an electrolytic solution (not illustrated). Moreover, a positive-pole lead 17a and a negative-pole lead 17b are connected to the positive-pole collector 12a and negative-pole collector 12b respectively and the both leads 17a and 17b penetrate a sealing body 18 and are taken to the outside of the case 16.

The positive electrode 14 and the negative electrode 15 (hereafter referred to as electrodes) are generally constituted by an active material, conductive material, and bonding material. An active material can be selected similarly to the case of the above embodiment 1. Though the same hold true for a conductive material and a bonding material used for an electrode, the electrode 14 and 15 respectively have a very small thickness, tens of microns different from the case of the coin shape of the embodiment 1. Therefore, carboxymethylcellulose or the like is used as a bonding material. Of course, it is necessary to select a material which is not deteriorated due to a conducive material, bonding material, voltage range used together, or temperature.

The separator 13 can be selected similarly to the case of the embodiment 1. However, because it is necessary to wind the collectors 12a and 12b, it is preferable that the separator 13 has certain degree of flexibility and therefore, aluminum or copper foil is generally used for the separator.

An electrolytic solution can be selected similarly to that in the case of the embodiment 1.

In the case of this embodiment, carbon-based conductive layers 19a and 19b respectively containing scaly graphite are formed on at least either of the composition plane between the positive electrode 14 and positive-pole collector 12a and that between the negative electrode 15 and negative-pole collector 12b or both of the planes in the case of this embodiment similarly to the case of the embodiment 1 in addition to the general configuration of the above energy accumulating device in order to suppress an internal resistance.

The energy-accumulating-device fabrication method of this embodiment is realized by a fabrication process using a carbon-based conductive-layer paste obtained by mixing scaly graphite with a binder and a solvent so that scaly graphite particles, the longitudinal direction of which is parallel to the contact face between the collectors 12a and 12b, are included more than those, the longitudinal direction of which is not parallel to the contact face, similarly to the case of the embodiment 1.

The binder and the solvent used for the carbon-based conductive-layer paste are the same as those used for the embodiment 1.

A coater can be used for the process for forming the carbon-based conductive layer of the cylindrical energy accumulating device of this embodiment. There is a method of moving the positive-pole collector 12a or the negative-pole collector 12b at a constant speed while coating the surface of the collector 12a or 12b with the above carbon-based conductive-layer paste and drying the collector 12a or 12b under a certain condition in the next step. In this case, by controlling the thickness of the paste, moving speed of a collector, and drying temperature, control can be performed so that scaly graphite particles, the longitudinal direction of which is parallel to the contact face of the collector, are included more than those, the longitudinal direction of which is not parallel to the contact face.

In general, the orientation ratio tends to rise as the drying speed lowers. Moreover, it is one of the optional methods to laminate-print a thin-film sheet and a collector controlled so that the orientation ratio in the longitudinal direction of scaly graphite particles previously rises.

In the case of the energy accumulating device of this embodiment, the contact area between scaly graphite particles in the carbon-based conductive layers 19a and 19b and the contact area between the scaly graphite particles and the collectors 12a and 12b are drastically increased compared to the case of conventional spherical graphite particles. Therefore, an internal resistance in the initial state can be reduced. Moreover, because the collectors 12a and 12b are covered with a resin contained in conductive particles or conductive-layer paste in a wider range, it is enabled to suppress leakage currents of the collectors 12a and 12b and decrease the deterioration rate.

Moreover, in the case of high-temperature exposure at the time of reflow or long-time operation at a high withstand voltage, even if a chemical reaction occurs between internally-sealed electrolytic solution and the carbon-based conductive layers 19a and 19b and a reaction product is produced, electron conductivity is kept because contact areas between the scaly graphite particles and between scaly graphite particles and the collectors 12a and 12b are large and an internal resistance rise is suppressed. Moreover, because a reactant is selectively attached to an end of a scaly graphite particle, the attachment of the reactant to an electron conducting route is suppressed and junction strength can be improved.

### EXAMPLES

The present invention is described below in detail by using specific examples.

First, examples 1 and 2 corresponding to the embodiment 1 and a conventional example 1 as a comparative example are described below.

### Conventional Example 1

Carbon-based conductive-layer paste was prepared by mixing scaly graphite with 1.0 wt % of acrylic resin and 2.5 wt % of isopropyl-alcohol aqueous solution and diffusing them, dropped to insides of bottomed cylindrical stainless-steel cases also serving as a pair of collectors corresponding to the collectors 2a and 2b in FIG. 1, and applied to them. Thereafter, they were dried in a constant-temperature bath at 60° C. for 10 min in atmospheric air to obtain a pair of stainless steel cases coated with a carbon-based conductive layer.

Then, activated-carbon particles (surface area of 1,500 m²/g, average particle diameter of 40 μm), Ketjen black, and polytetrafluoroethylene were mixed at a ratio of 7:2:1, formed into a cylindrical shape by a tablet shaping machine, and left as they were for 12 hr in an atmosphere of 150° C. to remove water and form a pair of electrodes.

The electrodes were held so that they were accurately kept on carbon-based conductive layers of the stainless steel cases. Then, the conventional example 1 was obtained by setting a cellulose-based separator between electrodes of the stainless steel cases and thereby combining the stainless steel cases, pouring an electrolytic solution obtained by dissolving 1.5 M of ethylmethyl-imidazolium-tetrafluorobonate in sulfolane into them, hydraulically caulking them through a gasket made of polyphenylene sulfide, and thereby electrically connecting the electrodes with the carbon-based conductive layer.

### Example 1

Carbon-based conductive-layer paste was prepared by mixing and diffusing scaly graphite with ethylene-acrylic acid and water, and it was dropped to insides of bottomed cylindrical stainless cases also serving as a pair of collectors to coat them through spin coating. Thereafter, they were dried in a constant-temperature bath at 60° C. for 10 min in atmospheric air to obtain a pair of stainless cases coated with a carbon-based conductive layer.

In this case, the thickness of scaly graphite particles was approx. 5 μm and the longitudinal length of them was 15 to 30 μm. Moreover, the thickness of the carbon-based conductive layer was 20 to 30 μm. As a result of SEM-observing the cross sections of the stainless steel cases coated with the carbon-based conductive layer, it was found that scaly graphite particles the longitudinal direction of which was parallel to faces of the stainless steel cases were 81%.

Thereafter, example 1 was obtained by forming a coin-shaped electric double-layer capacitor similarly to the case of the above conventional example 1.

### Example 2

A carbon-based conductive-layer paste was prepared by mixing and diffusing scaly graphite with polyamide, 50 wt % of N-methylpyrrolidone and 50 wt % of propylene-glycol monomethylacetate, and it was dropped to insides of a pair of bottomed cylindrical stainless-steel cases also serving as a pair of collectors to coat them through spin coating.

Thereafter, a pair of electrodes formed similarly to the case of the above conventional example were held so that they were accurately kept on wet carbon-based conductive layers of the stainless steel cases and dried in a constant-temperature bath at 340° C. for 60 min in nitrogen to obtain a pair of stainless steel cases coated with the carbon-based conductive layer and integrated with electrodes. As a result of SEM-observing cross sections of the stainless steel cases coated with the carbon-based conductive layer, it was found that scaly graphite particles, the longitudinal direction of which was parallel to stainless-steel-case faces, were 93%.

Thereafter, example 2 was obtained by forming a coin-shaped electric double-layer capacitor similarly to the case of the above conventional example 1.

For coin-shaped electric double-layer capacitors of the conventional example 1 and examples 1 and 2 formed as described above, the impedance at 1 kHz was measured in the initial state, after a cooling time of 30 min elapsed after the reflow in which preheating was performed for 2 min at 150° C. and main heating was performed for 40 sec at the highest temperature of 240° C., and after a constant-temperature load test at 3.3 V and 60° C. for 500 hr. Impedance measurement was executed for 10 samples in the case of each of the conventional example 1 and examples 1 and 2 and the average value of the results is shown in Table 1.

TABLE 1

| | Impedance at 1 kHz (Ω) | | |
|---|---|---|---|
| | Initial | After | After constant-temperature |
| | state | reflow | load test at 60° C. |
| Conventional | 39.4 | 53.9 | 3056.8 |
| example 1 | | | |
| Example 1 | 39.2 | 50.7 | 1281.0 |
| Example 2 | 36.0 | 43.0 | 850.1 |

Moreover, for coin-shaped electric double-layer capacitors of the conventional example 1 and examples 1 and 2 similarly fabricated, the impedance at 1 kHz was measured in the initial state and after a constant-temperature load test at 3.3 V and 60° C. for 500 hr without performing reflow. Impedance measurement was executed for 10 samples in the case of each of the conventional example 1 and examples 1 and 2 and the average value of the results are shown in Table 2.

TABLE 2

Impedance at 1 kHz (Ω)

| | Initial | After constant-temperature |
|---|---|---|
| | state | load test at 60° C. |
| Conventional example 1 | 40.3 | 964.4 |
| Example 1 | 40.5 | 370.1 |
| Example 2 | 35.4 | 318.7 |

As shown in Table 1, in the case of the examples 1 and 2, impedances after the reflow and constant-temperature load test are remarkably decreased compared to the case of the conventional example 1. Particularly, in the case of the example 2 in which an electrode is attached without drying a paste applied layer to integrate an electrode and a collector through carbon-based conductive-layer paste and then drying is executed, it is found that the impedance in the initial state can also be decreased.

Moreover, as clarified by the comparison with Table 2, it is found that resistance rise is accelerated due to reflow and this example has an effect of greatly suppressing the resistance rise rate.

Then, an example 3 corresponding to the embodiment 2 and a conventional example 2 as a comparative example are described below.

### Conventional Example 2

Carbon-based conductive-layer paste was prepared by mixing scaly graphite with 0.3 wt % of acrylic resin and 2.5 w % of isopropyl-alcohol aqueous solution and diffusing them. An aluminum foil, the surface of which was previously roughened through etching, was immersed in the carbon-base conductive-layer paste for several seconds and then pulled up and dried in a constant-temperature bath at 60° C. in atmospheric air for 10 min to obtain the aluminum foil (collector foil) coated with the carbon-based conductive-layer paste.

Moreover, 10 g of activated carbon and 4 g of acetylene black were sufficiently agitated and moreover, 40 cm³ of methyl alcohol and 100 cm³ of water were added to the acetylene black to further agitate them. Activated-carbon slurry was prepared by slowly adding 1.2 g of carboxymethylcellulose to the above mixture while stirring the mixture by a homogenizer.

Then, the aluminum foil coated with the carbon-based conductive-layer paste was immersed in the activated-carbon slurry and pulled up and then, dried for 30 min at ordinary temperature and for 1 hr at 105° C. Then, a part of the aluminum foil was ripped off and a lead was connected to the part through caulking. The size of the aluminum foil and the thickness of the electrode layer are designed so that the capacitance of the assembled electric double-layer capacitor becomes approx. 1 F. Two lead-provided activated-carbon electrodes thus obtained were wound like a cylinder by setting a separator made of viscose rayon between the electrodes and dried for approx. 24 hr at 150° C., immersed in an electrolytic solution for electric double-layer capacitor (propylene carbonate solution of 1 mol/l of tetraethyleneammonium tetrafluoroborate solution), and impregnated under reduced pressure. Finally, the capacitor device was set to a butyl-rubber sealing body on which a hole for a lead was previously opened and sealed in a cylindrical case made of aluminum to obtain an electric double-layer capacitor.

(Embodiment 3)

Carbon-based conductive-layer paste was prepared by mixing scaly graphite with ethylene-acrylic acid and water and diffusing them, an aluminum foil, the surface of which was previously roughened through etching, was immersed in the carbon-based conductive-layer paste for several seconds and then pulled up and dried in a constant-temperature bath at 60° C. in the atmospheric air for 10 min to obtain an aluminum foil (collector foil) coated with the carbon-based conductive layer.

Moreover, 10 g of activated carbon and 4 g of acetylene black were sufficiently agitated and then 40 cm³ of methyl alcohol and 100 cm³ of water were added to the mixture and then further agitated. Activated carbon slurry was prepared by slowly adding 1.2 g of carboxymethylcellulose while stirring the mixture by a homogenizer.

Then, the aluminum foil coated with the carbon-based conductive layer was immersed in activated-carbon slurry and pulled up and then dried for 30 min at ordinary temperature and for 1 hr at 105° C. Then, a part of the aluminum foil was ripped off and a lead was connected to the part through caulking. The size of the aluminum foil and the thickness of the electrode layer are designed so that the capacitance of the assembled electric double-layer capacitor become approx. 1 F.

Two lead-provided activated-carbon electrodes thus obtained were wound like a cylinder by setting a separator made of viscose rayon between the electrodes and dried for approx. 24 hr at 150° C., immersed in an electrolytic solution for electric double-layer capacitor (propylene carbonate solution of 1 mol/l of tetraethyleneammonium tetrafluoroborate solution), and impregnated under reduced pressure. Finally, the capacitor device was set to a butyl-rubber sealing body on which a hole for a lead was previously opened and sealed in a cylindrical case made of aluminum to obtain an electric double-layer capacitor.

For the cylindrical electric double-layer capacitors of the conventional example 2 and example 3 thus fabricated, the impedance at 1 kHz was measured in the initial state and after a constant-temperature load test at 3.0 V and 60° C. for 500 hr. Impedance measurement was executed for 10 samples in the case of each of the conventional example 2 and example 3 and the average value of the results is shown in Table 3.

TABLE 3

Impedance at 1 kHz (Ω)

| | Initial | After constant-temperature |
|---|---|---|
| | state | load test at 60° C. |
| Conventional example 2 | 1.2 | 2.7 |
| Example 3 | 1.1 | 1.5 |

As clarified from Table 3, the impedance of the example 3 after the constant-temperature load test remarkably becomes small compared to the case of the conventional example 2.

The above examples are explained by applying the present invention to an electric double-layer capacitor. However, the present invention is not restricted to an electric double-layer capacitor, but can be similarly applied to other electrochemical capacitor and battery.

The conductive layer of the present invention may be constituted by adding, for example, metallic particles to butyl rubber.

Not only graphite, but also other carbon-based conductive particles such as carbon nanotube may be used for the conductive particles of the present invention.

While there has been described what is at present considered to be preferred embodiments of this invention, it will be understood that various modifications may be made therein, and it is intended to cover in the appended claims all such modifications as fall within the true spirit and scope of this invention.

What is claimed is:

1. An energy accumulating device comprising a pair of electrodes, a separator set between the electrodes, a pair of collectors, a pair of conductive layers respectively set between the electrode and the collector, and an electrolytic solution, wherein
at least one of the conductive layers includes aspheric conductive particles extending at least in one direction.

2. The energy accumulating device as claimed in claim 1, wherein the conductive layer contains a resin component.

3. The energy accumulating device as claimed in claim 1, wherein the aspheric conductive particles extending at least in one direction are scaly graphite particles.

4. The energy accumulating device as claimed in claim 1, wherein the conductive layer includes the aspheric conductive particles the one direction of which is parallel to contact faces of the collectors more than the aspheric conductive particles the one direction of which is not parallel to the contact faces.

5. The energy accumulating device as claimed in claim 1, wherein energy is accumulated on interfaces between the electrodes and the electrolytic solution.

6. The energy accumulating device as claimed in claim 1, wherein a lead plate for mounting a substrate is set to the electrodes.

7. A fabrication method of an energy accumulating device including a pair of electrodes, a separator set between the electrodes, a pair of collectors, a pair of conductive layers respectively set between the electrode and the collector, and an electrolytic solution, comprising:
a step of preparing conductive-layer paste by mixing aspheric conductive particles extending at least in one direction with a binder and a solvent;
a sep of applying the obtained conductive-layer paste onto a collector;
a step of drying the obtained paste-applied layer; and
a step of electrically connecting an electrode onto the dried conductive layer.

8. A fabrication method of an energy accumulating device including a pair of electrodes, a separator set between the electrodes, a pair of collectors, a pair of conductive layers respectively set between the electrode and the collector, and an electrolytic solution, comprising:
a step of preparing conductive-layer paste by mixing aspheric conductive particles extending at least in one direction with a binder and a solvent;
a step of applying the obtained conductive-layer paste onto a collector;
a step of attaching an electrode without drying the obtained paste-applied layer; and
a step of drying an object obtained by integrating an electrode and a collector through conductive-layer paste.

9. The energy-accumulating-device fabrication method as claimed in claim 7, wherein the aspheric conductive particles extending at least in one direction are scaly graphite particles.

10. The energy-accumulating-device fabrication method as claimed in claim 8, wherein the aspheric conductive particles extending at least in one direction are scaly graphite particles.

11. The energy-accumulating-device fabrication method as claimed in claim 7, wherein the following step is included: a step of performing control so that the aspheric conductive particles the one direction of which is parallel to contact faces of the collectors are included more than the aspheric conductive particles the one direction of which is not parallel to the contact faces.

12. The energy-accumulating-device fabrication method as claimed in claim 8, wherein the following step is included: a step of performing control so that the aspheric conductive particles the one direction of which is parallel to contact faces of the collectors are included more than the aspheric conductive particles the one direction of which is not parallel to the contact faces.

13. The energy-accumulating-device fabrication method as claimed in claim 11, wherein the step of performing control is to spin-coat the collectors with the conductive-layer paste in the step of applying the obtained conductive-layer paste onto the collectors.

14. The energy-accumulating-device fabrication method as claimed in claim 12, wherein the step of performing control is to spin-coat the collectors with the conductive-layer paste in the step of applying the obtained conductive-layer paste onto the collectors.

15. The energy-accumulating-device fabrication method as claimed in claim 12, wherein the step of performing control is to mount an electrode without drying the paste-applied layer and then contact-bond it in the step of attaching an electrode without drying the obtained paste-applied layer.
